(19) United States
(12) Patent Application Publication
(10) Pub. No.: US 2014/0323189 A1
(43) Pub. Date: Oct. 30, 2014

(54) ADVERTISING GAME SYSTEM

(71) Applicant: YAHOO INC., Sunnyvale, CA (US)

(72) Inventor: Ankit Jhalaria, San Mateo, CA (US)

(73) Assignee: Yahoo Inc., Sunnyvale, CA (US)

(21) Appl. No.: 13/871,613

(22) Filed: Apr. 26, 2013

(51) Int. Cl. A63F 13/00

(52) U.S. Cl. CPC A63F 13/005
USPC 463/9

(57) ABSTRACT

An advertising game system can include a user interface, e.g., a graphical user interface (GUI), configurable to output, e.g., display, a clue related to a brand. The output of the clue may be a part of a game. The user interface may also be configurable to display a user input field configurable to receive a guess of the brand. The user interface may also be configurable to display an advertisement related to the brand, where a received guess identifies the brand. The system can also include a processor communicatively coupled to the user interface. The processor may be executable to determine whether a received guess identifies the brand.

### BACKGROUND

Example embodiments relate to interactive advertising.

Examples of online advertisements may include ads on search engine results, banner ads, rich media ads, social network advertising, interstitial ads, e-mail ads, such as e-mail spam, and the like. A common theme in online advertising is that the displayed ads can be viewed or clicked on.

### BRIEF DESCRIPTION OF THE DRAWINGS

The system may be better understood with reference to the following drawings and description. Non-limiting and non-exhaustive examples are described with reference to the following drawings. The components in the drawings are not necessarily to scale, emphasis instead being placed upon illustrating the principles of the system. In the drawings, like referenced numerals designate corresponding parts throughout the different views.

FIG. 1 illustrates a block diagram of an example of a network that can implement one or more aspects of an advertising game system.

FIG. 2 illustrates a block diagram of an example of an electronic device that can implement one or more aspects of an advertising game system.

FIGS. 3A, 3B, and 4-6 illustrate flowcharts of example operations of one or more aspects of an advertising game system.

### DETAILED DESCRIPTION

Described herein is an advertising game system (AGS) that provides advertising to audiences in the form of an interactive game, e.g., an online game. The interactive game and components of the game may be created by advertisers or agents of advertisers. Components of the game also may be created by other parties, e.g., Internet users, that are not affiliated with the advertisers. Allowing parties unaffiliated with the advertisers to create the game components provides a form of advertising, since a party creating a game component actively thinks about a brand while creating the component.

In an example, the game provides clues with respect to a brand of an advertiser. A user playing the game may guess from the clues, the brand and/or the advertiser. Where the user guesses the brand and/or the advertiser correctly, the game may perform an action, e.g., present an advertisement of the brand to the user. Additionally, the user may recommend the game to a contact, e.g., a friend. This feature may be especially useful where provided through online social networking services.

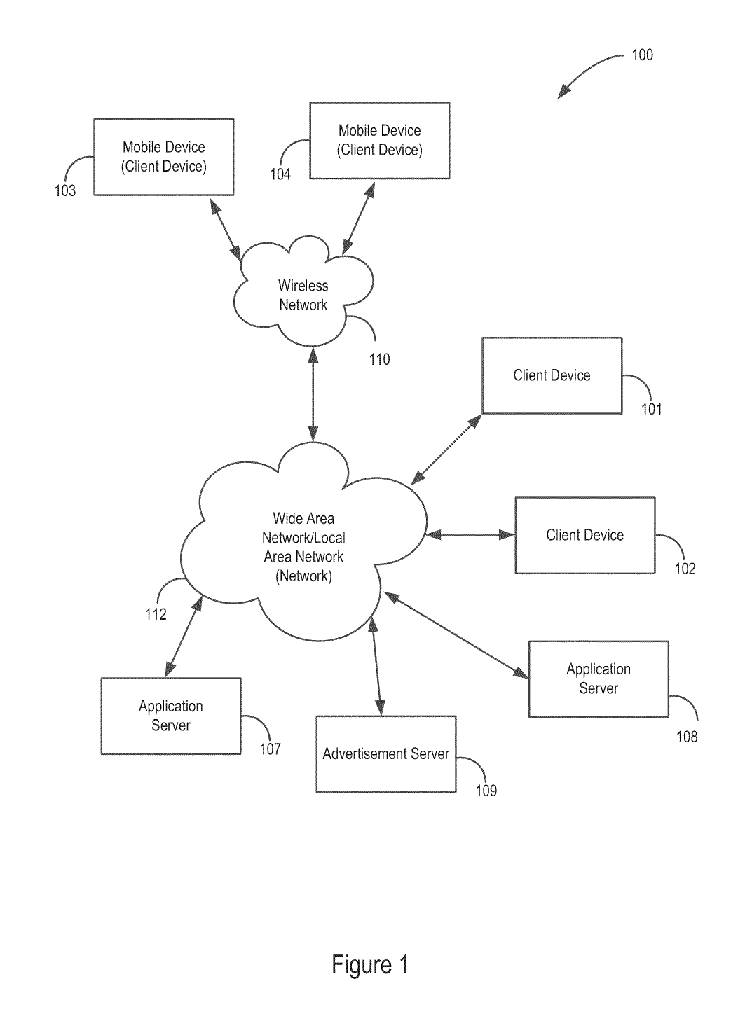

FIG. 1 illustrates a block diagram of an example of a network that can implement one or more aspects of the AGS. As shown in FIG. 1, for example, a network 100 includes a variety of networks, e.g., local area network (LAN)/wide area network (WAN) 112 and wireless network 110, a variety of devices, e.g., client devices 101 and 102, mobile devices 103 and 104, application servers 107 and 108 (such as web, email, and/or messaging, and/or search servers), and advertisement server 109. A network, e.g., the network 100, may couple devices so that communications may be exchanged, e.g., between a server and a client device or other types of devices, including between wireless devices coupled via a wireless network, for example.

The application servers can provide content and/or applications to a user or an audience. The user can view or use the content and/or applications from a client device, e.g., a mobile client device. Integrated with the content and/or applications, advertisements may be received from advertisement sources, e.g., advertisement servers.

Software, hardware, and/or firmware that provide one or more aspects of the AGS may be stored or embedded at a client device and/or a server, e.g., an application server or an advertisement server. Also, the source of one or more aspects of the AGS may be communicated from one device to another. For example, software that may enable some aspects of the AGS may be communicated from a server to a client device.

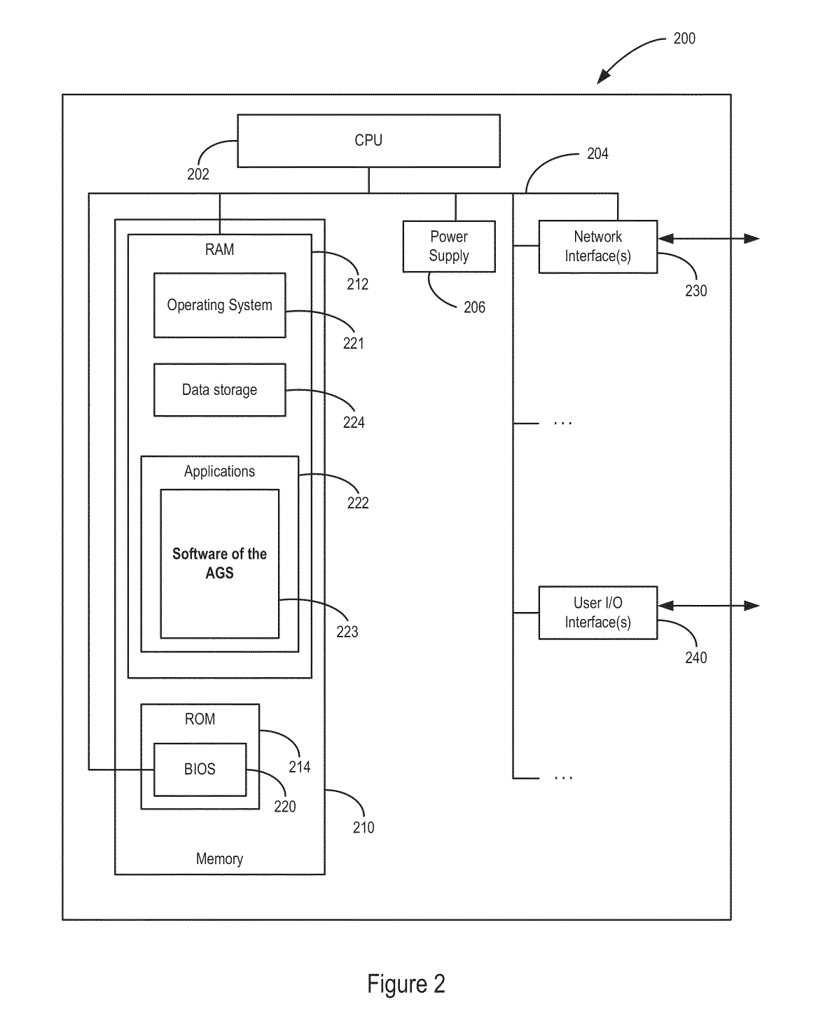

FIG. 2 illustrates a block diagram of an example of an electronic device 200 that can implement one or more aspects of the AGS. Instances of the electronic device 200 may include servers, e.g., servers 107-109, and client devices, e.g., client devices 101-104. A client device may be a desktop computer, a laptop computer, a tablet, or a smartphone, for example. In general, the electronic device 200 can include a processor 202, memory 210, a power supply 206, and input/output components, e.g., network interface(s) 230 and user input/output interface(s) 240 (such as microphones, speakers, displays, touchscreens, keypads, and keyboards). Displays and touchscreens being operable to provide graphical user interfaces. The electronic device 200 can also include a communication bus 204 that connects the aforementioned elements of the electronic device. The network interfaces 230 can include a receiver and a transmitter (or a transceiver), and an antenna for wireless communications. The processor 202 can be one or more of any type of processing device, e.g., a central processing unit (CPU). Also, for example, the processor 202 can be central processing logic. Central processing logic may include hardware, firmware, software and/or combinations of each to perform a function(s) or an action(s), and/or to cause a function or action from another component. Also, based on a desired application or need, central processing logic may include a software controlled microprocessor, discrete logic, e.g., an application specific integrated circuit (ASIC), a programmable/programmed logic device, memory device containing instructions, or the like, or combinational logic embodied in hardware. Also, logic may also be fully embodied as software. The memory 210, which can include RAM 212 or ROM 214, can be enabled by one or more of any type of memory device, e.g., a primary (directly accessible by the CPU) and/or a secondary (indirectly accessible by the CPU) storage device (e.g., flash memory, magnetic disk, optical disk). The RAM can include an operating system 221, data storage 224, and applications 222, e.g., example software aspects of the AGS 223. The ROM can include BIOS 220 of the electronic device 200. The power supply 206 contains one or more power components, and facilitates supply and management of power to the electronic device 200. The input/output components can include any interfaces for facilitating communication between any components of the electronic device 200, components of external devices (e.g., components of other devices of the network 100), and end users. For example, such components can include a network card that may be an integration of a receiver, a transmitter, and one or more I/O interfaces. A network card, for example, can facilitate wired or wireless communication with other devices of a network. In cases of wireless communication, an antenna can facilitate such communication. Also, some of the I/O interfaces and the bus 204 can facilitate communication between components of the electronic device 200, and in an example can ease processing performed by the processor 202.

A client device may vary in terms of capabilities or features. For example, a client device may include or may execute a variety of possible applications, e.g., a client software application enabling communication with other devices, e.g., communicating one or more messages regarding operation or configuration of the AGS. A client device may also include or execute an application to communicate content related to the AGS, e.g., textual content, multimedia content, or the like. A client device may also include or execute an application to perform a variety of possible tasks, e.g., browsing, searching, or analyzing forms of content related to the AGS.

Where the electronic device 200 is a server, it can include a computing device that can be capable of sending or receiving signals, e.g., via a wired or wireless network, or may be capable of processing or storing signals, e.g., in memory as physical memory states, and may, therefore, operate as a server. Particularly, the server may be an application server that includes a configuration to provide an application, e.g., example aspects of the AGS, via a network to another device. Also, an application server may, for example, host a website that can provide a user interface for administration of example aspects of the AGS.

Further, an application server may provide a variety of services that include web services, third-party services, audio services, video services, email services, instant messaging (IM) services, short message service (SMS) services, multimedia messaging service (MMS) services, file transfer protocol (FTP) services, voice over IP (VOIP) services, calendaring services, photo services, or the like, all of which may work in conjunction with example aspects of the AGS. Examples of content provided by application servers, including advertisements, advertisement teasers, and clues with respect to brands, may include text, images, audio, video, or the like, which may be processed in the form of physical signals, e.g., electrical signals, for example, or may be stored in memory, as physical states, for example.

In an example aspect of the AGS, e.g., a client device aspect of the AGS, the aspect may include one or more user interfaces, e.g., user input/output interface(s) 240, and a controller that at least controls the user interface. The interface(s) and the controller may be part of or associated with one or more electronic devices, e.g., one or more client devices. The controller may be a processor, e.g., processor 202, configurable to execute instructions stored in memory, e.g., memory 210. The user interface may be configurable to provide a game to a user. For example, the user interface may be configurable to output, e.g., output visually via a display and/or audibly via speakers, a clue related to a brand and a user input field configurable to receive a guess of the brand. The user interface may also be configurable to output an advertisement related to the brand, where a received guess identifies the brand. The controller, which can be communicatively coupled to the user interface, e.g., coupled via a bus, e.g., bus 204, may be executable to determine whether a received guess identifies the brand.

The AGS may also include a communications interface, e.g., network interface(s) 230, communicatively coupled to the processor and configurable to receive the clue, the advertisement, and an identification of the brand from an advertisement server via a network e.g., the network 100. The memory device may be configurable to store the clue, the advertisement, and the identification of the brand.

Regarding the game, the clue may be a first clue, and the user interface may further be configurable to output a second clue related to the brand, where the received guess does not identify the brand. The outputting of new clues may occur until a determined threshold is met or exceeded, such as exceeding a time limit or a limit of guesses. The user interface may also be further configurable to output the advertisement, where the determined threshold is met or exceeded. For example, the advertisement may be outputted where an amount of received guesses is greater than a determined threshold. Also, the user interface may be configurable to output a user input field configured to receive a request from a user to send a message to a contact of the user, e.g., a friend, an acquaintance, a family member, or a business associate. The message may include a reference to the game or the advertisement. The communications interface may be configurable to transmit the message to a device of the contact. Subsequent to transmitting the message to the device of the contact, the user interface may be further configured to: output an indication that the message was sent to the contact, output an indication that the game was played by the contact, output an indication that the brand was correctly or incorrectly guessed by the contact. Also, the user interface may be further configured to: output an indication that the user has been or will be compensated because the contact played the game and/or viewed and/or listened to the advertisement.

In another example aspect of the AGS, e.g., a server computer aspect of the AGS, the aspect may include one or more communications interfaces and a controller communicatively couple to the interface(s). The communications interface(s) and the controller may be part of or associated with one or more electronic devices, e.g., one or more server computers. One of the communications interfaces, for example, may be configurable to receiving a first message including a clue, an advertisement, and an identification of a brand associated with an advertiser. The first message may be sent from an electronic device of a first user unaffiliated with the advertiser. The communication interface may also be configured to transmit a second message including the clue, the advertisement, the indication of the brand, and a game. The second message may be transmitted to an electronic device of the first user and/or a second user unaffiliated with the advertiser. The clue, the advertisement, and the indication of the brand may be parts of the game. The clue may be related to the brand and the advertisement. The communications interface may also be configurable to receive an indication that the advertisement was outputted by the electronic device of the second user. Also included, may be memory that is configurable to store an indication to provide compensation to the first user based on at least the indication that the advertisement was outputted by the electronic device of the second user.

In an example, where the first user communicates the message including creatives to a game serving aspect of the AGS, the first user may be provided with an agreement that assigns the intellectual property associated with the creatives to the advertiser. In another example, such an agreement may not be executed until the first user is compensated.

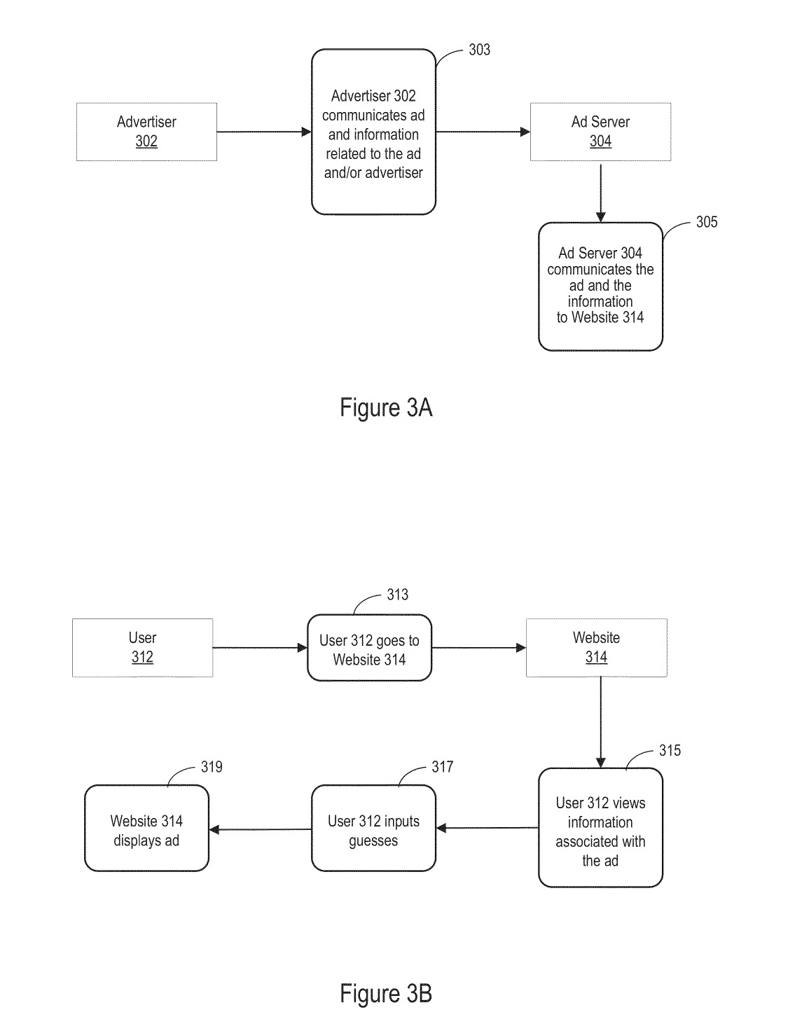

FIGS. 3A and 3B illustrate flowcharts of example methods that can be performed by one or more aspects of the AGS, e.g., one or more aspects of the electronic device 200. At 303, an advertiser 302 or agent of the advertiser may communicate an advertisement along with information related to the advertisement and/or the advertiser. The communicating at 303 may be to an advertisement server 304, e.g., the advertisement server 109. Alternatively, the advertisement and the associated information may originate from an advertisement server. In another example, the communicating may be to an application server, e.g., the application server 107 or 108. At 305, the advertisement server 304 communicates the advertisement and the associated information to a website 314. The website 314 may be produced by an application server, e.g., the application server 107 or 108.

At 313, a user 312, e.g., a user unaffiliated with the advertiser, may visit the website 314. At 315, the user 312 may view the information associated with the advertisement, e.g., a clue with regard to a brand of the advertiser 302. At 317, the user 312 may provide guesses with regard to a brand of the advertiser 302. Eventually, upon the user guessing a correct brand, for example, the website 314 displays the advertisement at 319.

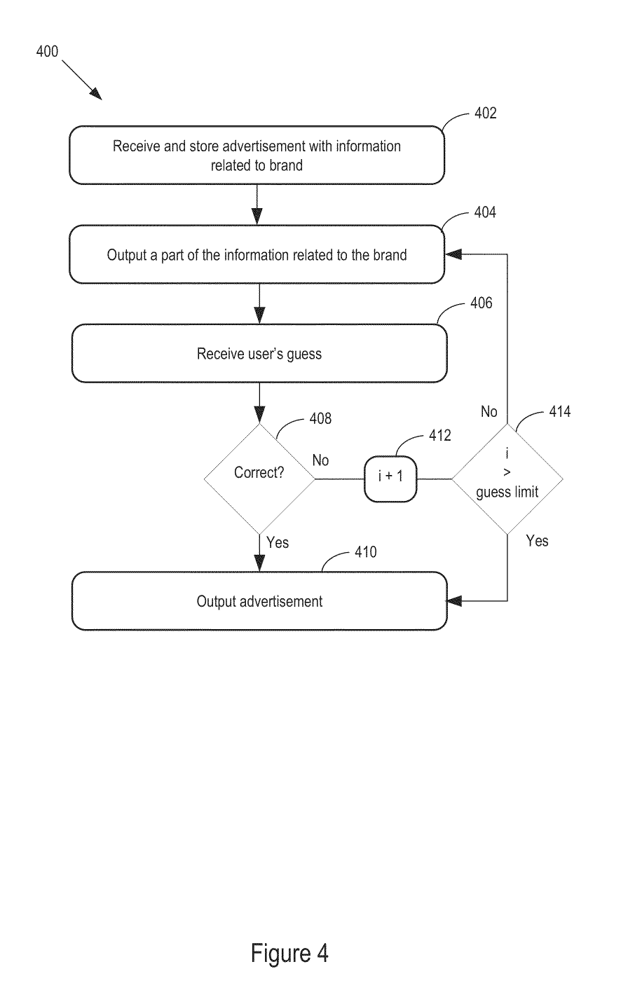

FIG. 4 illustrates a flowchart of an example method that can be performed by one or more aspects of the AGS, e.g., one or more aspects of the electronic device 200 (method 400). For example, the method 400 may include a client device running an application, e.g., a web browser, that can receive and store an advertisement and information related to a corresponding brand, e.g., a teaser, at 402. A teaser may be an audio and/or visual output that provides a clue as to the corresponding brand. For example, the teaser may be a graphically outputted tagline. The advertisement and the information related to the corresponding brand may be communicated from an application server or an advertisement server, e.g., the servers 107-109.

Also included may be a user interface, e.g., user input/output interface(s) 240, which may output a part of the information related to the brand at 404. For example, included may be a display outputting a graphical user interface (GUI) that can output at least a part of the information related to the corresponding brand, for example. The user interface can receive a user input, e.g., a guess as to which brand is the corresponding brand, at 406.

Also included may be a processor or control unit, e.g., processor 202, to make determinations and facilitate execution of operations described herein. For example, the processor or control unit may execute instructions of any one or more parts of memory, e.g., memory 210, to perform operations described herein. Where the user's guess is determined to be correct by the processor or control unit at 408, in that the user guesses the corresponding brand, the user interface can output, e.g., display, the advertisement at 410. Where the user's guess is determined to be incorrect, the processor or control unit of the AGS can track the incorrect guess, e.g., by a counter at 412. Where a value of the counter is below a threshold at 414, the user interface can output the at least part of the information related to the brand or another part of the information at 404. The user can repeatedly try to guess the brand from outputted teasers. The guessing can occur until a threshold is exceeded. Where the threshold is exceeded at 414, the processor or control unit can cause an action, e.g., outputting the advertisement via the user interface at 410.

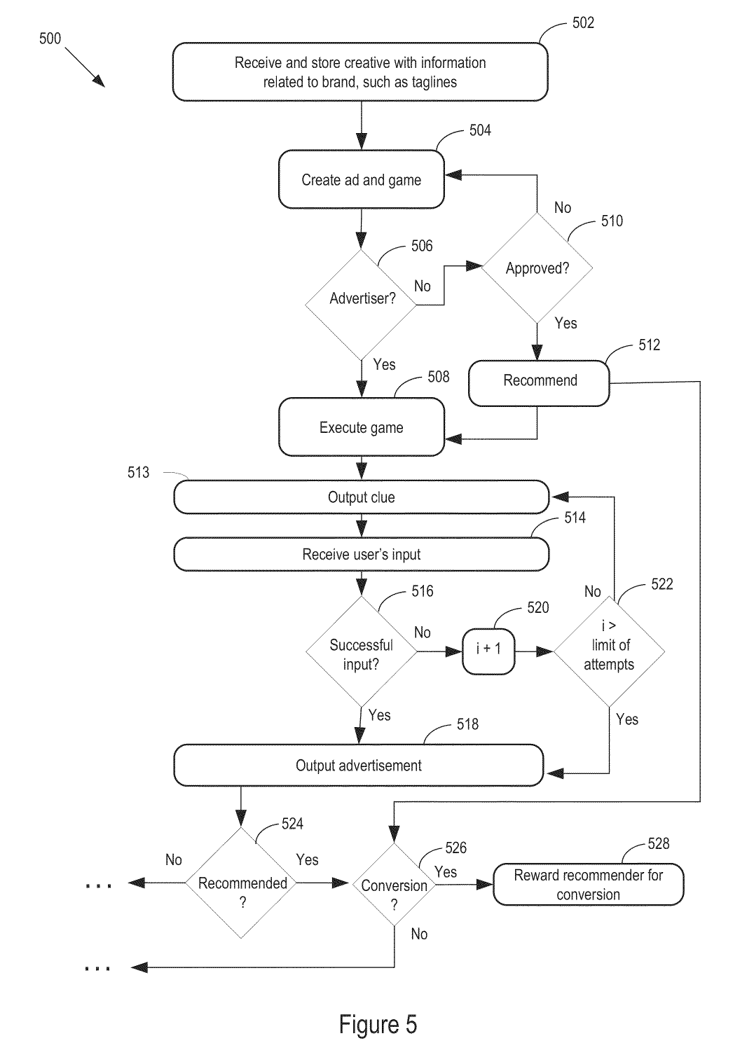

FIG. 5 illustrates a flowchart of an example method that can be performed by one or more aspects of the AGS, e.g., one or more aspects of the electronic device 200 (method 500). A receiving aspect of the AGS may receive a creative with information related to a corresponding brand, such an advertisement with one or more associated taglines at 502. The creative and the information associated with the brand can also be stored by a storage aspect of the AGS at 502. The receiving and the storing aspect being communicatively coupled to each other and other aspects of the AGS.

At 504, an advertiser or an end user, e.g., an audience member of an advertisement, targeted or not, can create an advertisement game and a corresponding ad. The game and the advertisement can be derived from the creative and the information related to the brand.

The advertisement game can have similar operations to those described with respect to method 400. In other words, the game can include providing clues to a user with respect to a corresponding brand. The user can try to guess the brand repeatedly, but can be limited to a number of tries. Where a user guesses the brand via user input, an advertisement, e.g., an advertisement derived from the creative, can be outputted to the user. The advertisement can also be outputted to the user if the user has gone over a limit of guesses. The game or the advertisement may be recommended to other users by the user. Also, the recommender may be rewarded. The reward may be one time or may correspond to a frequency or number of conversions that result from the user's recommendations to other users.

At 506, a processing aspect of the AGS determines whether the created advertisement and game was created by an advertiser or a user, e.g., a regular user unaffiliated with the advertiser. If the advertisement and game are created by the advertiser or an agent of the advertiser, the game and advertisement can be published for execution at 508. If the advertisement and game are created from a user unaffiliated with the advertiser, then the advertiser or an agent of the advertiser must approve the advertisement and game for publication at 510. Where the advertisement and game are not approved, the user may edit or create another game and/or advertisement at 504. Where the advertisement and game are approved, the user may publish the game by recommending it to another user, e.g., another unaffiliated user at 512. The other user may seek out the game as per the recommendation and execute the game at 508. Once the game is executed, a clue as to a brand, e.g., a tagline and/or an associated image and/or sound, may be outputted to a user at 513.

At 514, the user may respond to the outputted clue by making a guess as to the brand via a user input into a user input aspect of the AGS. At 516, a processing aspect of the AGS can determine if the input is correct. Where it is correct the advertisement may be presented to the user, e.g., via a display at 518. Where it is not correct, a counter can track the mistake at 520. At 522, a processing aspect of the AGS determines whether the counter has exceeded a limit. Where the counter has exceeded the limit of guesses, the advertisement is presented at 518. Where the limit has not been reached, another clue may be outputted at 513.

The outputted advertisement and/or the game at 518 may be recommended to another user by user that played the game. At 524, a processing aspect of the AGS determines whether an outputted advertisement and/or game was recommended by a recommender. If not, the processing aspect performs an action, e.g., logging the outputting of the ad. Where the advertisement and/or game was recommended and observed and/or used by another user, the recommender may be rewarded for the conversion at 528. Whether a conversion occurs may be determined at 526 by a processing aspect of the AGS. Conversions by receivers of recommend games or ads can be determined to reward the first user, or determined to reward any following user that makes recommendations. Where a conversion is determined not to have occurred at 526, the processing aspect may perform an action, e.g., logging zero conversions.

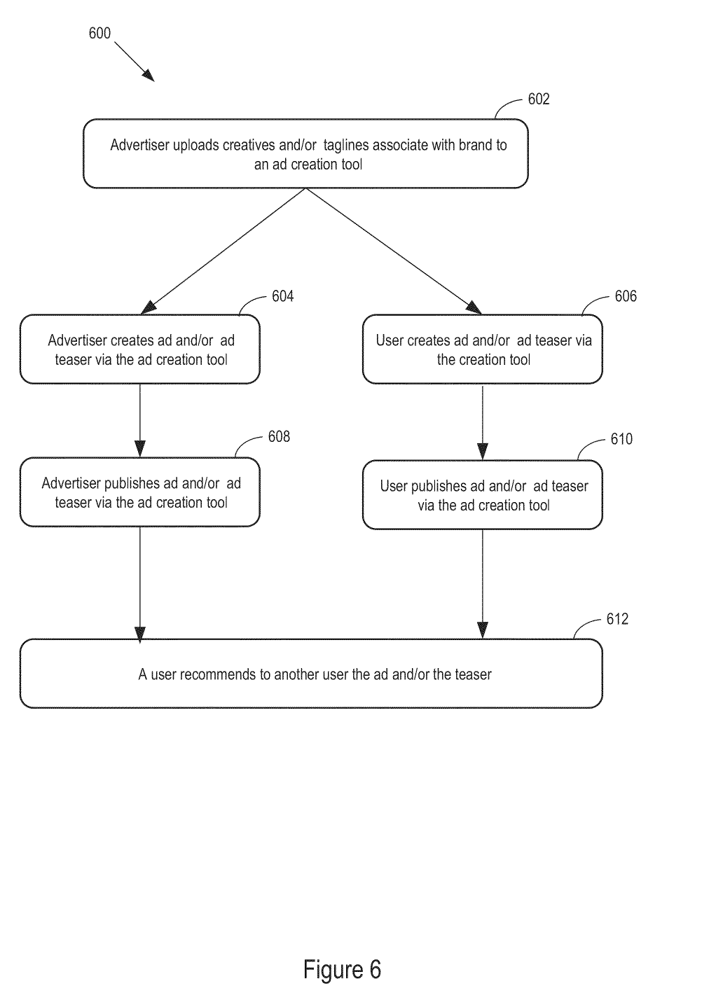

FIG. 6 illustrates a flowchart of an example method that can be performed by one or more aspects of the AGS, e.g., one or more aspects of the electronic device 200 (method 600). In this example, similar to the examples in FIGS. 3A and 3B, an advertiser may initially upload creatives. At 602, the advertiser upload creatives and/or taglines associated with a brand of the advertiser. This can be done via an online advertisement creation tool. Additionally or alternatively, a user can initially upload the creatives and/or the taglines, e.g., uploading the creatives and/or the taglines via the advertisement creation tool.

The advertisement creation tool can include fields for communicating creatives, e.g., audio and/or video files, that can be used to create an advertisement. Fields for taglines can also be included. Taglines may be stored in a database, and tagline database entries may be associated with fields of the online advertisement creation tool.

At 604 and at 606, the advertiser and the unaffiliated user, respectively, may create an advertisement or advertisement campaign and teasers via the online advertisement creation tool. At 608 and 610, the advertiser and the unaffiliated user, respectively, may publish the advertisement or campaign and the teasers via the advertisement creation tool. At 612, the unaffiliated user or another user may recommend the advertisement, an advertisement of the campaign, or the teaser to another user, e.g., a friend, family member, or business associate.

As it can be imagined, there are various examples for providing and deriving the system described herein. It is therefore intended that the foregoing detailed description be regarded as illustrative rather than limiting, and that it be understood that forthcoming claims, and their equivalents, are intended to define the spirit and scope of this system.

We claim:

1. A system comprising:
a user interface configured to:
output a user input field configured to receive a request from a user to send a message to a contact of the user, the message including a reference to a game;
output a clue related to a brand, the output of the clue being a part of the game;
output a user input field configured to receive a guess of the brand; and
output an advertisement related to the brand, where a received guess identifies the brand;
a processor, communicatively coupled to the user interface, configured to determine whether a received guess identifies the brand; and
a communications interface, communicatively coupled to the processor, configured to transmit the message to a device of the contact.

2. The system of claim 1, wherein the user interface is further configured to output an indication that the message was sent to the contact.

3. The system of claim 1, wherein the user interface is further configured to output an indication that the game was played by the contact.

4. The system of claim 1, wherein the user interface is further configured to output an indication that the brand was correctly guessed by the contact.

5. The system of claim 1, wherein the user interface is further configured to output an indication that the brand was incorrectly guessed by the contact.

6. The system of claim 1, wherein the user interface is further configured to output an indication that the user has been or will be compensated because the contact played the game.

7. The system of claim 1, wherein the user interface is further configured to output an indication that the user has been or will be compensated because the contact was presented the advertisement.

8. A system, comprising:
a graphical user interface (GUI) configured to:
display a clue related to a brand, the display of the clue being a part of a game;
display a user input field configured to receive a guess of the brand; and
display an advertisement related to the brand, where a received guess identifies the brand; and
a processor communicatively coupled to the GUI executable to determine whether a received guess identifies the brand.

9. The system of claim 8, further comprising: a communications interface, communicatively coupled to the processor, configured to receive the clue, the advertisement, and an identification of the brand from an advertisement server.

10. The system of claim 9, further comprising: a memory device, communicatively coupled to the processor, configured to store the clue, the advertisement, and the identification of the brand.

11. The system of claim 8, wherein the clue is a first clue, and wherein the GUI is further configured to display a second clue related to the brand, where the received guess does not identify the brand.

12. The system of claim 8, wherein the GUI is further configured to display the advertisement, where an amount of received guesses is greater than a determined threshold.

13. An electronic device implemented method, comprising:
receiving, at a communications interface, a first message including a clue, an advertisement, and an identification of a brand associated with an advertiser, the first message being sent from an electronic device of a first user unaffiliated with the advertiser;
transmitting, by the communications interface, a second message including the clue, the advertisement, the indication of the brand, and a game, wherein the second message is transmitted to an electronic device of a second user unaffiliated with the advertiser, wherein the clue, the advertisement, and the indication of the brand are parts of the game, and wherein the clue is related to the brand and the advertisement;
receiving, at the communications interface, an indication that the advertisement was outputted by the electronic device of the second user; and
storing, at a memory device, an indication to provide compensation to the first user based on at least the indication that the advertisement was outputted by the electronic device of the second user.

14. The method of claim 13, wherein the game includes instructions executable by a processor to output via a user interface of an electronic device, a request to receive a guess of the brand.

15. The method of claim 13, wherein the game includes instructions executable by a processor to determine whether a received guess identifies the brand.

16. The method of claim 15, wherein the game includes instructions executable by a processor to output the advertisement via a user interface of an electronic device, where the received guess identifies the brand.

17. The method of claim 15, wherein the clue is a first clue, and wherein the game includes instructions executable by a processor to output via a user interface of an electronic device, a second clue related to the brand, where the received guess does not identify the brand.

18. The method of claim 13, wherein the game includes instructions executable by a processor to output the advertisement via a user interface of an electronic device, where an amount of received guesses is greater than a determined threshold.

19. The method of claim 13, wherein the game includes instructions executable by a processor to output via a user interface of an electronic device, a user input field configured to receive a request from a user to send a message to a contact of the user, the message including a link to the game.

20. The method of claim 19, wherein the game includes instructions executable by a processor to output via a user interface of an electronic device:
an indication that the game was sent to the contact,
an indication that the brand was correctly guessed by the contact,
an indication that the brand was incorrectly guessed by the contact,
an indication that the user has been or will be compensated because the contact played the game or was presented the advertisement.
